(19) United States
(12) Patent Application Publication
(10) Pub. No.: US 2015/0046342 A1
(43) Pub. Date: Feb. 12, 2015

(54) SYSTEM AND METHOD FOR TELEMATICS SERVICE OF VEHICLE

(71) Applicant: HYUNDAI MOTOR COMPANY, Seoul (KR)

(72) Inventor: Byoung Wook LEE, Seoul (KR)

(73) Assignee: HYUNDAI MOTOR COMPANY, Seoul (KR)

(21) Appl. No.: 14/099,799

(22) Filed: Dec. 6, 2013

(30) Foreign Application Priority Data
Aug. 12, 2013 (KR) 10-2013-0095614

(51) Int. Cl. G06Q 10/00

(52) U.S. Cl. CPC G06Q 10/20
USPC 705/305

(57) ABSTRACT

Disclosed are a system and a method for a telematics service of a vehicle through which various vehicle related services such as a remote diagnosis or an e-Call can be continuously used through a gateway without causing a compatibility problem even when a telematics unit is replaced. The system for a telematics service includes: a gateway having a service stub file containing cooperation execution information of a telematics service; and a telematics unit configured to request and receive a service stub file from the gateway. A service stub is created for connection to the gateway and execution of cooperation of a service based on information in the service stub file received from the gateway.

### CROSS-REFERENCE TO RELATED APPLICATION

This application claims under 35 U.S.C. §119(a) the benefit of Korean Patent Application No. 10-2013-0095614, filed on Aug. 12, 2013, the entire contents of which are incorporated herein by reference.

### TECHNICAL FIELD

The present disclosure relates to a system and a method for a telematics service of a vehicle. More particularly, the present disclosure relates to a system and a method for a telematics service of a vehicle by which compatibility between a vehicle gateway and a telematics unit can be secured, the service can be easily expanded, and an extension of a user information technology (IT) device to the telematics service can be improved.

### BACKGROUND

Telematics is a combination of telecommunications and informatics, and refers to a technology of transmitting, receiving, and storing information through a communication device.

Recent advancements in telematics include vehicles using a combination of a navigation system using Global Positioning System (GPS) technology and mobile communication technology.

For example, a GPS and a Geographic Information System (GIS) are combined with a vehicle to inform a driver of traffic information in real time through a telematics unit of a vehicle; a smart device, such as a smart phone and a tablet PC; and a mobile communication terminal, such as a mobile phone and a personal digital assistant (PDA) to provide guidance on the road.

The telematics system has various applications in a vehicle, such as a breakdown diagnostic service for electrical/mechanical components mounted in a vehicle; a remote diagnostic service using vehicle information, such as breakdown codes of an electronic control unit or various sensor information; a vehicle control service, such as a remote startup; an inter-vehicle communication service between a call center and a vehicle or a telematics unit; an intelligent traffic system; an emergency rescue service; a multimedia service that provides entertainment, such as the Internet, a video, a movie, and a game; and realization of an interface between a user and a vehicle.

Basically, when a vehicle is provided with a telematics service from the outside, a telematics unit of the vehicle transmits various collected information, such as a vehicle state to an external Telematics Service Provider (TSP) and a telematics server having received information from the telematics unit provides service information obtained through a series of information processing processes to the telematics unit of the vehicle.

Further, when a vehicle breakdown or accident occurs, the telematics unit can transmit vehicle state diagnosis information, position information, and camera image information to a telematics server, thereby allowing the user to receive information on how to deal with the accident, emergency service, and road traffic situation information service from the telematics server.

In a recent automatic emergency call (e-Call) system, when an accident or an emergency situation occurs, a telematics unit of a vehicle automatically transmits an emergency signal, including information necessary for a rescue. Such information may include: vehicle location, destination, driving direction, and a registration number of the vehicle to a specific external receiver, and provide a service that allows the user to be connected to an organization for managing an emergency service through voice communication depending on the state of a driver after transmission of data.

Meanwhile, in configuring a vehicle network system, various protocols that define communication standards between devices are used and the representative protocols include Controller Area Network (CAN), Local Interconnect Network (LIN), FlexRay, and Ethernet.

In addition, various protocols capable of exhibiting advantages in a vehicle have been developed, and integrated network systems capable of connecting protocols of different types of vehicles through conversion of data between protocols and integratedly managing the protocols have been developed.

As well known in the art, central gateways have been used to transmit and receive data between various networks in a vehicle network system, and are becoming main elements for associating services of vehicle devices such as an electronic control unit with services of external devices such as a telematics unit and a user IT device (smart device).

Here, the vehicle gateway serves to separate communication domains and support routing between the domains at a center to distribute bus loads of a vehicle and prevent internal data from being discharged. Further, the gateway serves to provide data information in a vehicle and to manage control services, and allows a telematics unit to provide various vehicle related services, for example, a telematics service such as a remote diagnosis or e-Call while acting as a relay between the vehicle and an external device.

However, an unbalance may occur due to a difference between technical development speeds of an internal function and a telematics unit of a vehicle, and gateways and telematics platforms are different for different types of vehicles, making it difficult to manage compatibility.

In particular, in a situation in which a technical development speed of a telematics unit is very high, various problems related to compatibility occurs when a telematics unit employing the recent technologies is applied.

Although a standard interface between a vehicle gateway, a telematics unit, and an external device is defined to be standardized, interfaces still should be improved.

Further, a measure for reducing a burden of a development subject due to management of specifications of gateways and telematics units for different types of vehicles, and a measure for easily extending user IT devices and realizing association of services are desirable.

### SUMMARY

The present disclosure has been made in an effort to solve the above-described problems associated with the prior art. The present disclosure provides a system and a method for a telematics service of a vehicle by which various vehicle related services such as a remote diagnosis or an e-Call can be continuously used through a gateway without causing a compatibility problem even when a telematics unit is replaced.

The present disclosure also provides a system and a method for a telematics service of a vehicle by which an interface between a vehicle gateway and a telematics unit and a compatibility for automatically creating a user interface (UI) in the telematics unit can be secured, service can be easily expanded, and an extension problem of a user IT device (a smart phone and a tablet PC) for a telematics service can be improved.

In accordance with an aspect of the present disclosure, there is provided a system for a telematics service of a vehicle, including: a gateway having a service stub file containing cooperation execution information of a telematics service; and a telematics unit configured to request and receive a service stub file from the gateway, create a service stub for connection to the gateway, and execute cooperation of a service based on information in the service stub file received from the gateway.

The gateway may include a service module for execution of cooperation of a service with the telematics unit and a service broker for managing the service module. The telematics unit creates a service stub module for executing cooperation of a service with a service module of the gateway by using information in the service stub file received from the gateway, and a service stub user interface (UI) for a user input.

The service stub file may contain information including a service name, a service request ID, a service response frequency, a response ID, a service response field, and a UI layout.

The system may further include an external device for performing a telematics service in association with the gateway of the vehicle through the telematics unit. The telematics unit may transfer the service stub file according to a request of an external device to create a service stub in the external device and associate a service between the gateway and the external device.

In accordance with another aspect of the present disclosure, there is provided a method for a telematics service of a vehicle, including transmitting a service stub file containing cooperation execution information of a telematics service by a gateway according to a request of a telematics unit while a connection of the gateway and the telematics unit is completed. A service stub is created for connection to a gateway and execution of cooperation of a service based on information in the service stub file received from the gateway by the telematics unit. A service is executed through a request and a response of a service between the telematics unit and the gateway.

The gateway and the telematics unit may be completely connected via a verification process after a physical connection is made through a network.

The telematics unit may create a service stub module for executing cooperation of a service with a service module of a gateway by using information in a service stub file received from the gateway and a service stub user interface (UI) for a user input.

The service stub file may contain information including a service name, a service request ID, a service response frequency, a response ID, a service response field, and a UI layout.

The method may further include performing a telematics service by associating the gateway of the vehicle with an external device through the telematics unit. The telematics unit transfers the service stub file according to a request of an external device to create a service stub in the external device and associate a service between the gateway and the external device.

According to the system and method for a telematics service of the present disclosure, by automatically creating a service stub module and a UI for providing a service in a telematics module based on a service stub file transferred from a gateway, a telematics unit can be replaced by a telematics unit employing a recent technology without causing a compatibility problem. In addition, an interface can be maintained and a telematics service can be provided and managed. For example, a service can be provided and managed even in the case of an aftermarket product when an interface is maintained.

Further, a burden of a development subject according to management of specifications of a gateway and a telematics for different types of vehicles can be reduced, compatibility between devices can be secured, service can be easily expanded, and an extension of a device can be improved.

### BRIEF DESCRIPTION OF THE DRAWINGS

The above and other features of the present disclosure will now be described in detail with reference to certain exemplary embodiments thereof illustrated the accompanying drawings which are given hereinafter by way of illustration only, and thus are not limitative of the present disclosure.

FIG. 1 is a block diagram illustrating a system for a telematics service of a vehicle according to an embodiment of the present disclosure.

FIG. 2 is a flowchart for a telematics service of a vehicle according to an embodiment of the present disclosure.

FIG. 3 is a view illustrating a structure of a service stub file, a service stub UI, and a module of an automatically configured telematics unit.

FIG. 4 is a view for explaining an extension to a vehicle external device, that is, a user information technology (IT) device when the present disclosure is applied.

It should be understood that the appended drawings are not necessarily to scale, presenting a somewhat simplified representation of various preferred features illustrative of the basic principles of the disclosure. The specific design features of the present disclosure as disclosed herein, including, for example, specific dimensions, orientations, locations, and shapes will be determined in part by the particular intended application and use environment.

In the figures, reference numbers refer to the same or equivalent parts of the present disclosure throughout the several figures of the drawing.

### DETAILED DESCRIPTION

Hereinafter, exemplary embodiments of the present disclosure will be described in detail with reference to the accompanying drawings so that those skilled in the art to which the present disclosure pertains can easily carry out the present disclosure.

The present disclosure relates a system and a method for a telematics system by which compatibility can be secured through automatic creation of an interface between a central gateway and a telematics unit and a User Interface (UI) in the telematics unit, an associated external device (a smart device, such as a smart phone, a tablet PC, or other user IT devices) can be extended, and a service can be expanded.

To achieve this, a system is provided in which different platforms can communicate with each other by dynamically creating protocols, while not being restricted by a specific environment. A telematics service cooperation technique is also provided that forms an active communication connection and a link between a vehicle gateway and a telematics unit through transfer of a service stub file between the vehicle gateway and the telematics unit in a process of creating a dynamic protocol.

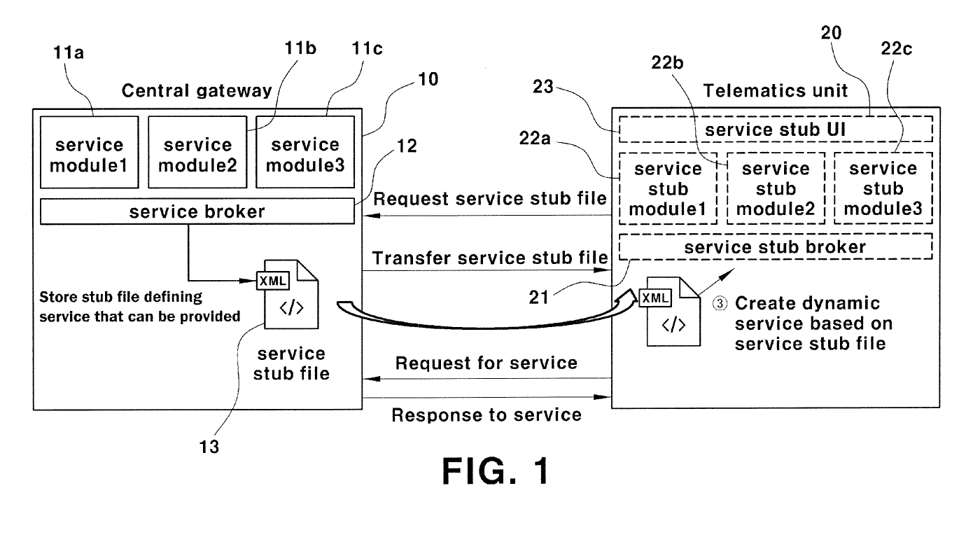

FIG. 1 is a diagram illustrating a system for a telematics service of a vehicle according to an embodiment of the present disclosure, and illustrates a flow of a cooperation technique of a service between a gateway 10 and a telematics unit 20 together with a configuration of the system.

As illustrated, the system for a telematics service of the present disclosure includes a gateway 10 including a service stub file 13 containing cooperation execution information of a telematics service to actively create an interface and a communication link between the gateway 10 and the telematics unit 20. The telematics unit 20 requests and receives a service stub file 13 from the gateway 10, creates service stub modules 22a to 22c and a service stub user interface (UI) 23 for connection to the gateway, and executes cooperation of a service by using information in the service stub file received from the gateway 10.

Further, in the service method of the present disclosure, when a service cooperation request from the telematics unit 20 is received, the gateway 10 transmits the service stub file 13 to the telematics unit 20 and the telematics unit 20 dynamically creates a service stub for connection to the gateway and execution of cooperation of a service based on a service stub file received from the gateway 10, so that a communication link for cooperation of a service with the gateway is created.

In the system configuration, the gateway 10 includes service modules 11a to 11c for execution of cooperation of services with the telematics unit 20, and includes a service broker 12 for managing the service modules 11a to 11c.

A service stub file 13 that defines a telematics service (a service, such as e-Call, a remote diagnosis, and a remote startup) is created and is stored in a local area when the vehicle is released.

The telematics unit 20 has a logic for requesting the service stub file 13 of the gateway 10, and includes a service stub broker 21 for analyzing information of the service stub file 13 and dynamically creating the service stub modules 22a to 22c and service stub UI 23.

Accordingly, when the telematics unit 20 is mounted in a vehicle and is initially connected to the gateway 10, the telematics unit 20 requests a service stub file from the gateway according to the logic.

In addition, the telematics unit 20 automatically creates the service stub modules 22a to 22c for executing service cooperation with the gateway 10 and the service modules 11a to 11c by using information in the service stub file transferred from the gateway 10, and a service stub UI 23 for a user input.

The telematics unit 20 receives an operation request from an external device and a service stub UI 23 and performs association and cooperation of a service with the gateway 10.

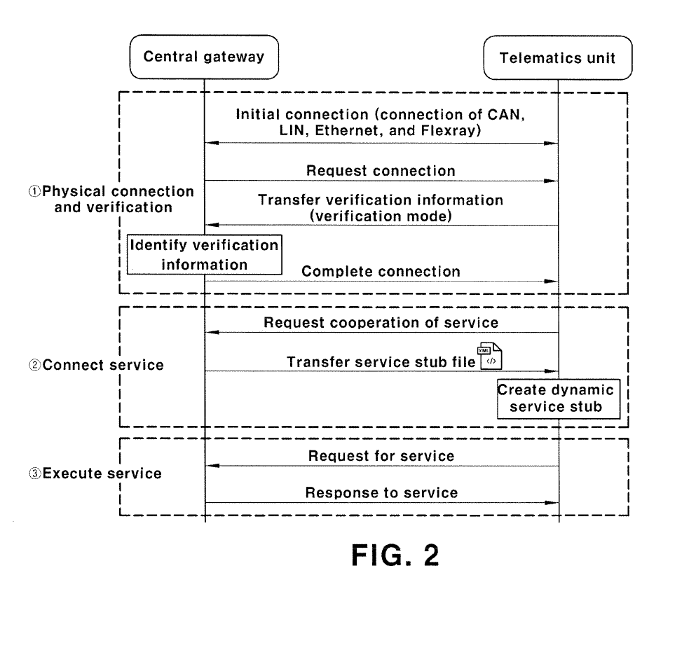

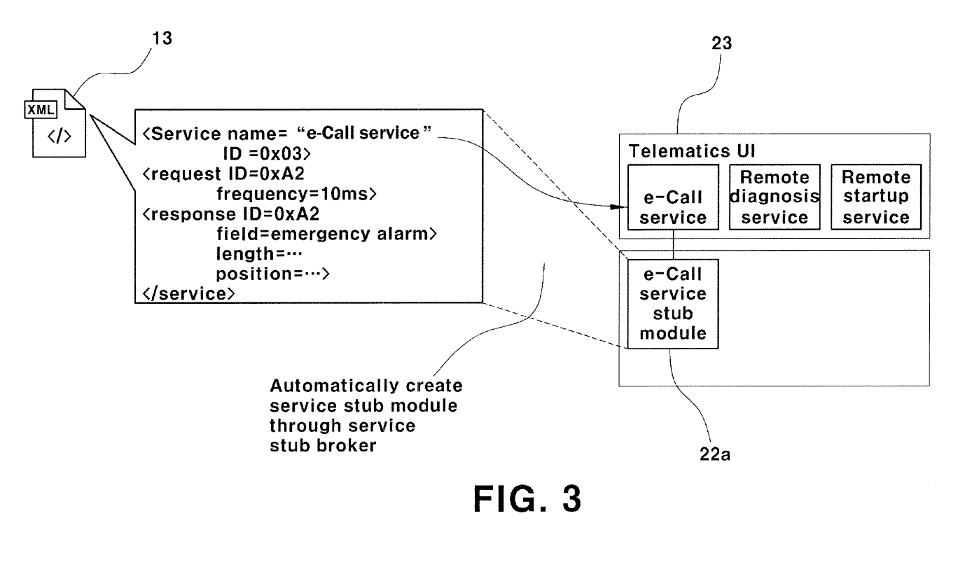

FIG. 2 is a flowchart illustrating a method for a telematics service of a vehicle according to an embodiment of the present disclosure, and illustrates a detailed flow of a cooperation technique for a service between the gateway and the telematics unit. FIG. 3 shows that physical connection and verification, connection of a service, and execution of a service between the gateway and the telematics unit are performed to provide a telematics service.

If a physical connection is achieved between the gateway and the telematics unit in the physical connection and verification step, that is, if the telematics unit is mounted in the vehicle and is initially connected to the gateway through a network such as CAN, LIN, FlexRay, and Ethernet, the gateway makes a connection request (request for verification information) according to a logic of an internal program and the telematics unit transfers verification information such as a verification code in response.

Accordingly, the gateway identifies verification information received from the telematics unit to perform a verification operation according to a predetermined verification algorithm, and the connection is completed if the verification is successfully performed.

In a state where the connection is completed, the telematics unit requests a service cooperation according to a logic of the internal program in the service connection step, and in this process, the telematics unit requests a service stub file from the gateway and the gateway transfers the service stub file.

Accordingly, the telematics unit performs a dynamic service stub creating process, and a service stub module and a service stub UI for association of a service of the vehicle and execution of cooperation are configured by using information in the service stub file received from the gateway in the process.

Thereafter, a response of a service of a telematics unit is made according to a request for the service in the service executing step, and the telematics service is executed in the request and response process.

The physical connection and verification step and the service connection step are performed only once when the telematics unit is initially connected to the gateway, and then, only a process of executing a telematics service, that is, the service execution step is performed through the request and response of a service.

FIG. 3 is a view exemplifying a structure of a service stub file, and a service stub module and a UI of an automatically configured telematics unit. FIG. 3 shows an example of a service stub file 13 transmitted from the gateway to the telematics unit, and shows a telematics UI for association of an e-Call service, a remote diagnosis service, and a remote startup service as an example of the service stub UI 23.

In the present disclosure, the service stub file 13 may be written in a language such as eXtensible Markup Language (XML), and as exemplified, contains information such as a service name, a service request ID, a service response frequency, a response ID, a service response field, and a UI layout.

Since the service stub file 13 contains all the information on a mutual service cooperation between the gateway and the telematics unit, upon receiving the service stub file 13, the telematics unit analyzes information of the service stub file 13 through an analyzer such as a service stub broker to configure the stub module 22a corresponding to the service module of the gateway, and may configure a vehicle association UI 23 of the telematics unit for a user through a service name and layout information of the service stub file 13.

In this way, according to the present disclosure, by automatically creating a service stub module and a UI for providing a service in a telematics module based on a service stub file transferred from a gateway, a telematics unit can be replaced by a telematics unit employing recent technology without causing a compatibility problem, and an interface can be maintained and a telematics service can be provided and managed (a service can be provided and managed even in the case of an aftermarket product when an interface is maintained).

Further, a burden of having to manage different specifications for different types of vehicles the gateway and the telematics unit can be significantly reduced, and an extension can be easily made to a new IT device.

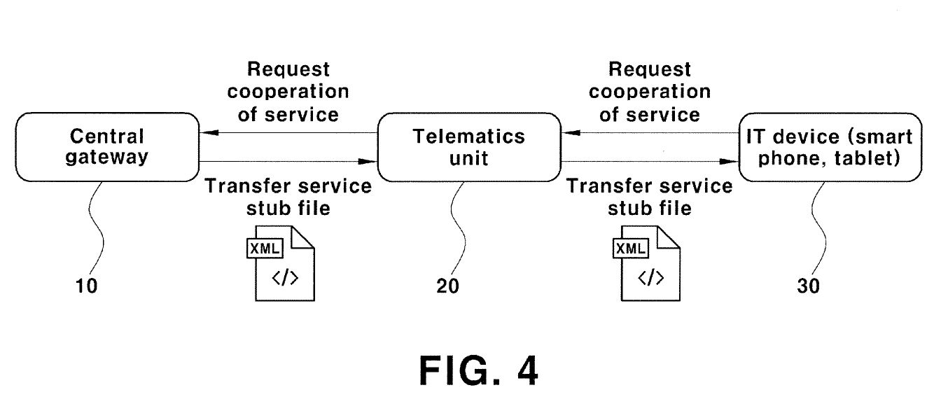

FIG. 4 explains an extension to a vehicle external device, such as, applying the present disclosure to a user IT device 30. As exemplified, when a user intends to associate the gateway 10 and the telematics service 20 through the IT device 30, the telematics unit 20 can act as a relay between the vehicle gateway 10 and the user IT device 30. The IT device 30 may dynamically configure a service stub in the telematics unit by using the service stub file transferred from the gateway 20 through the telematics unit 20, thereby allowing extension of an IT device and association of a service. In this way, the telematics service system may further include a user IT device (external device) 30 that performs a telematics service in association with the gateway 10 through the telematics unit 20. Then, the telematics unit transfers a service stub file according to a request of a user IT device to allow a service stub to be created in the IT device and a service to be performed between the gateway and the IT device in association.

While the exemplary embodiments of the present disclosure have been described as transferring a service stub file, a method of the gateway storing an application (application program) of a service that can be operated in the telematics unit and distributing the application to the telematics unit when the telematics unit is initially connected also falls within the scope of the present disclosure.

Although the embodiments of the present disclosure have been described in detail, the scope of the present disclosure is not limited thereto and various modifications and improvements made by those skilled in the art by using the basic concept of the present disclosure defined in the claims also fall within the scope of the present disclosure.

What is claimed is:

1. A system for a telematics service of a vehicle, comprising:
a gateway having a service stub file containing cooperation execution information of a telematics service; and
a telematics unit configured to request and receive the service stub file from the gateway, create a service stub for connection to the gateway, and execute cooperation of a service based on information in the service stub file received from the gateway.

2. The system of claim 1, wherein the gateway comprises a service module for execution of cooperation of a service with the telematics unit and a service broker for managing the service module, and the telematics unit creates a service stub module for executing cooperation of a service with a service module of the gateway by using information in the service stub file received from the gateway and a service stub user interface (UI) for a user input.

3. The system of claim 1, wherein the service stub file contains information including a service name, a service request ID, a service response frequency, a response ID, a service response field, and a UI layout.

4. The system of claim 1, further comprising an external device for performing a telematics service in association with the gateway of the vehicle through the telematics unit, and the telematics unit transfers the service stub file according to a request of an external device to create a service stub in the external device and associate a service between the gateway and the external device.

5. A method for a telematics service of a vehicle, comprising:
transmitting a service stub file containing cooperation execution information of a telematics service by a gateway according to a request of a telematics unit while a connection of the gateway and the telematics unit is completed;
creating a service stub for connection to a gateway and execution of cooperation of a service based on information in the service stub file received from the gateway by the telematics unit; and
executing a service through a request and a response of a service between the telematics unit and the gateway.

6. The method of claim 5, wherein the gateway and the telematics unit are completely connected via a verification process after a physical connection is made through a network.

7. The method of claim 5, wherein the telematics unit creates a service stub module for executing cooperation of a service with a service module of a gateway by using information in a service stub file received from the gateway, and a service stub user interface (UI) for a user input.

8. The method of claim 5, wherein the service stub file contains information including a service name, a service request ID, a service response frequency, a response ID, a service response field, and a UI layout.

9. The method of claim 5, further performing a telematics service by associating the gateway of the vehicle with an external device through the telematics unit, wherein the telematics unit transfers the service stub file according to a request of an external device to create a service stub in the external device and associate a service between the gateway and the external device.
